(19) United States
(12) Patent Application Publication
(10) Pub. No.: US 2026/0310423 A1
(43) Pub. Date: Oct. 8, 2026

(54) HIERARCHICAL LEADER-QUORUM SYSTEM FOR MULTI-AGENT MODEL COLLABORATION

(71) Applicant: Intuit Inc., Mountain View, CA (US)

(72) Inventors: Siddharth JAIN, Mountain View, CA (US); Venkat Narayan VEDAM, Mountain View, CA (US); Sivashanker THIRUCHITTAMPALAM, Toronto (CA)

(73) Assignee: Intuit Inc., Mountain View, CA (US)

(21) Appl. No.: 19/098,794

(22) Filed: Apr. 2, 2025

(51) Int. Cl. G06F 8/35; G06F 8/36; G06F 11/34

(52) U.S. Cl. CPC G06F 8/35; G06F 8/36; G06F 11/3495

(57) ABSTRACT

Hierarchical leader-quorum system for multiple agent collaboration includes decomposing, by a large language model (LLM) of a central context management layer (CML), a software generation task specified in a natural language into multiple subtasks specified in a structured format. At least one subtask attribute of each corresponding subtask is matched to quorum data of a respective quorum, and transmitted, for each subtask assignment, the corresponding subtask to the respective quorum according to the subtask assignment. Further, a leader agent model of the respective quorum assigns the corresponding subtask to at least one agent model. The at least one agent model processes the corresponding subtask to generate software. The software generated by the quorums is combined. The software is presented.

### BACKGROUND

Software development is the process of generating code for performing particular tasks. Generally, software development is a complicated process in which a task that the software is to perform involves various subtasks. Each subtask has different requirements in order to generate the subtask. Further, the dependencies between subtasks can be complicated.

Computer systems may be specifically configured to perform automatic code generation. To specifically configure a computer system, the computer system may implement a generalized machine learning model that performs the software code generation. For example, the computer system may include a large language model that is configured to receive a request to create code that performs a task. The creation of such code by a generalized machine learning model may be subject to hallucinations or may result in sub-optimal code. On the other side, specifically trained machine learning models may not have the specialization to perform the overall task. Thus, a problem exists in designing a computer system that implements machine learning to perform automatic code development.

### SUMMARY

In general, in one aspect, one or more embodiments relate to a method. The method includes decomposing, by a large language model (LLM) of a central context management layer (CML), a software generation task specified in a natural language into multiple subtasks specified in a structured format, matching at least one subtask attribute of each corresponding subtask of the subtasks to quorum data of a respective quorum of multiple quorums to obtain multiple subtask assignments, and transmitting, for each subtask assignment of the subtask assignments, the corresponding subtask to the respective quorum according to the subtask assignment. The method further includes assigning, by a leader agent model of the respective quorum, the corresponding subtask to at least one agent model of multiple agent models, processing, by the at least one agent model, the corresponding subtask to generate software, combining, by the central CML, the software generated by the quorums, and presenting, after combining the software, the software.

In general, in one aspect, one or more embodiments relate to a system including at least one storage device and at least one computer processor for executing instructions stored on the at least one storage device for causing the system to perform operations. The operations include decomposing, by a large language model (LLM) of a central context management layer (CML), a software generation task specified in a natural language into multiple subtasks specified in a structured format, matching at least one subtask attribute of each corresponding subtask of the subtasks to quorum data of a respective quorum of multiple quorums to obtain multiple subtask assignments, and transmitting, for each subtask assignment of the subtask assignments, the corresponding subtask to the respective quorum according to the subtask assignment. The operations further include assigning, by a leader agent model of the respective quorum, the corresponding subtask to at least one agent model of multiple agent models, processing, by the at least one agent model, the corresponding subtask to generate software, combining, by the central CML, the software generated by the quorums, and presenting, after combining the software, the software.

In general, in one aspect, one or more embodiments relate to a method that includes decomposing, by a large language model (LLM) of a central context management layer (CML), a software generation task specified in a natural language into multiple subtasks specified in a structured format, matching at least one subtask attribute of each corresponding subtask of the subtasks to quorum data of a respective quorum of multiple quorums to obtain multiple subtask assignments, and transmitting, for each subtask assignment of the subtask assignments, the corresponding subtask to the respective quorum according to the subtask assignment. The method further includes assigning, by a leader agent model of the respective quorum, the corresponding subtask to at least one agent model of multiple agent models, processing, by the at least one agent model, the corresponding subtask to generate software, and combining, by the central CML, the software generated by the quorums. The method further includes executing, after combining the software, the software.

Other aspects of one or more embodiments will be apparent from the following description and the appended claims.

### BRIEF DESCRIPTION OF DRAWINGS

FIG. 1 shows a diagram of a system in accordance with one or more embodiments of the invention.

FIG. 2 shows a diagram of a central context management layer in accordance with one or more embodiments.

FIG. 3 shows a flowchart of operations of a central context management layer in accordance with one or more embodiments.

FIG. 4 shows a flowchart of operations of a leader agent model in accordance with one or more embodiments.

FIG. 5 shows a diagram of hierarchical task decomposition in accordance with one or more embodiments.

FIG. 6A shows a diagram of a quorum with example leader election in accordance with one or more embodiments.

FIG. 6B shows a diagram of a quorum with example leader election in accordance with one or more embodiments.

FIG. 7 shows a diagram of inter quorum and intra quorum communications in accordance with one or more embodiments.

FIG. 8A shows a diagram of aggregating results in accordance with one or more embodiments of the invention.

FIG. 8B shows an example of agent outputs in accordance with one or more embodiments.

FIG. 9 shows an example output schema in accordance with one or more embodiments.

FIG. 10 shows an example agent profile structure in accordance with one or more embodiments.

FIG. 11 shows an example of a leader to agent message in accordance with one or more embodiments.

FIG. 12 shows an example of an agent to leader message in accordance with one or more embodiments.

FIG. 13 shows an example output of an agent model in accordance with one or more embodiments.

FIG. 14 shows an example inter quorum message in accordance with one or more embodiments.

FIG. 15 shows an example output separating tasks and subtasks in accordance with one or more embodiments.

FIG. 16 shows an example of an agent profile in accordance with one or more embodiments.

FIG. 17 shows an example of a quorum configuration in accordance with one or more embodiments.

FIG. 18 shows an example of a communication log entry in accordance with one or more embodiments.

FIG. 19 shows an example of an agent profile metrics in accordance with one or more embodiments.

FIG. 20A and FIG. 20B show a computing system in accordance with one or more embodiments.

Like elements in the various figures are denoted by like reference numerals for consistency.

### DETAILED DESCRIPTION

One or more embodiments are directed to a hierarchical leader-quorum system (HLQS) for code generation by multiple agent models. The system includes a hierarchical set of specialized agent models. Each specialized agent model is a specifically trained machine learning model to generate software code performing a type of subtask of a task. For example, a first specialized agent model may be specifically trained to generate code accessing a database. Another specialized agent model may be specifically trained to generate code that creates a graphical user interface (GUI). To manage the agent models, the agent models are partitioned into quorums. A quorum is a group of agent models that are each trained to perform the same type or types of subtasks. The quorum of agent models has a leader agent model based on the properties of the leader agent model. The leader agent model manages the assignments of subtasks to agent models and combines output of the agent models. Quorums may communicate with each other based on dependencies between subtasks. Further, the hierarchical leader-quorum system for multi-agent model code generation collaboration includes a central context management layer (CML). The CML includes a generalized large language model that performs natural language processing on the task to decompose the task into subtasks. The CML is further configured to assign the subtasks to quorums. By implementing the hierarchical system, the computing system is better able to generate error free and optimized object code.

More generally, the HQLS is a comprehensive system designed to optimize collaboration and decision-making in multi-agent model environments, particularly in Large Language Models (LLMs) environment. HLQS may address challenges in distributed artificial intelligence by integrating dynamic agent profiling, adaptive leader election, quorum formation with defined communication protocols, robust aggregation mechanisms, and a central CML. The CML serves as the backbone of HLQS, orchestrating the entire process through centralized data management, state synchronization, and coordination services. By interweaving the components of the HLQS, the HLQS ensures scalability, robustness, and accuracy, enabling agent models with diverse expertise to collaboratively tackle complex tasks efficiently.

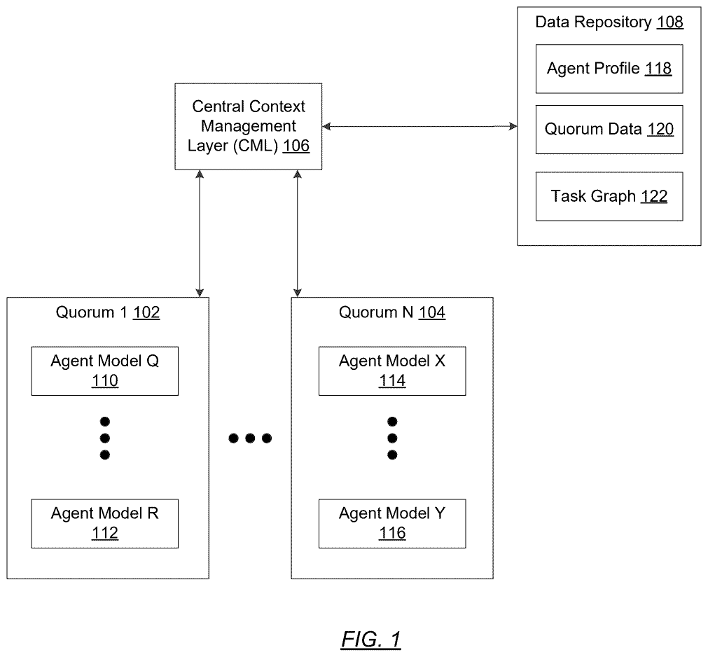

Attention is now turned to the figures. FIG. 1 shows a diagram of a system in accordance with one or more embodiments of the invention. The system shown in FIG. 1 includes a quorum (e.g., quorum 1 (102), quorum N (104)), a central context management layer (CML) (106), and a data repository (108). The quorum (e.g., quorum 1 (102), quorum N (104)) is a collection of agent models (e.g., agent model Q (110), agent model R (112), agent model X (114), agent model Y (116)). The agent models in a quorum are capable of performing the same type or types of subtasks. Namely, a quorum is a grouping of agent models to which tasks of a particular type may be assigned. Within the quorum, the agent models may be of heterogeneous types and may have heterogeneous training. Thus, the agent models may have different accuracy levels and resource usage for different task.

The agent models (e.g., agent model Q (110), agent model R (112), agent model X (114), agent model Y (116)) are machine learning models that are capable of software code generation. For example, the agent models may be neural network models, or a transformer model. A neural network model operates using one or more layers of parameters that may be sequentially applied to sets of input data, which may be referred to as input vectors. For each layer of a machine learning model, the computing functions of the layer that use the parameters may be applied to the input vector of the layer to generate an output for the layer that may be fed, as input data, to a next layer within the machine learning model. The output of the machine learning model may be the output generated from the last layer within the machine learning model. As an example, the layers may include layers for recurrent neural networks, convolutional neural networks, transformer models, attention layers, perceptron models, etc. The agent models may include different types of machine learning algorithms that may be used, including regression, decision trees, random forests, support vector machines, clustering, classifiers, principal component analysis, gradient boosting, etc.

The agent models may be trained by inputting training data to a machine learning model to generate training outputs that are compared to expected outputs. For supervised training, the expected outputs may be labels associated with a given input. For unsupervised learning, the expected outputs may be previous outputs from the machine learning model. The difference between the training output and the expected output may be processed with a loss function to identify updates to the weights of the layers of the model. After training on a batch of inputs, the updates identified by the loss function may be applied to the machine learning model to generate a trained machine learning model. Different algorithms may be used to calculate and apply the updates to the machine learning model, including back propagation, gradient descent, etc.

A central CML (106) is connected to a quorum (e.g., quorum 1 (102), quorum N (104)). The central CML (106) is a central framework for receiving and processing tasks. The central CML (106) is configured to receive a natural language description of a task to generate software, interpret the natural language description, decompose the task into subtasks, and assign subtasks to quorums. The central CML and the quorums may be connected to a data repository (108).

The data repository (108) is a type of storage unit or device (e.g., a file system, database, data structure, or any other storage mechanism) for storing data. The data repository (108) may include multiple different, potentially heterogeneous, storage units and/or devices. The data repository (108) includes functionality to store an agent profile (118), quorum data (120), and a task graph (122). In one or more embodiments, each agent model has an individual corresponding agent profile for the agent model. The agent profile (118) is a description of the agent model. Specifically, the agent profile (118) includes properties about the corresponding agent model. The properties in the agent profile (118) may include an agent model identifier that is a unique identifier of the agent model, a quorum identifier of a quorum to which the agent model belongs, metrics describing performance of the agent model, and other aspects about the agent model.

The quorum data (120) is data describing a particular quorum. Each quorum may have a corresponding set of quorum data. The quorum data includes the agent identifiers of agent models assigned to the quorum. Further, the quorum data may include an identifier of the leader agent model of the leader of the quorum. Further, for example, the quorum data may include a description of one or more types of subtasks of agents in the quorum.

The task graph (122) is a directed acyclic graph of the subtasks of the task. Each node in the task graph (122) corresponds to a particular subtask of the task. Edges in the task graph (122) correspond to dependencies between the nodes. A directed edge exists from a first node to a second node when the output of the second node is dependent on the first node. In one or more embodiments, the task graph (122) is generated by the central CML (106).

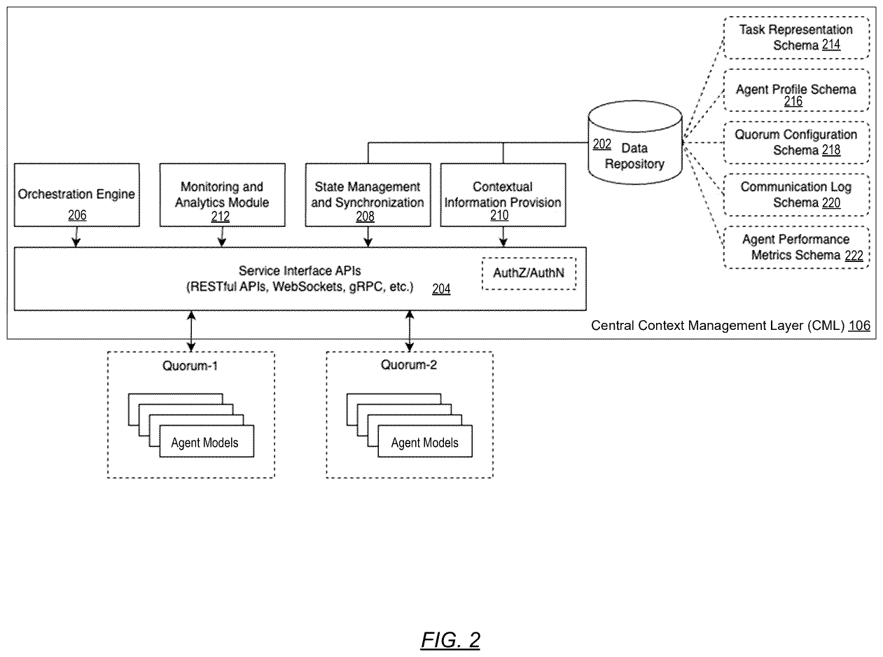

FIG. 2 shows a diagram of a central CML in accordance with one or more embodiments. In FIG. 2, the quorums, agent models, and central CML are the same as the quorums and agent models described above in FIG. 1.

As shown in FIG. 2, the central CML (106) includes a data repository (202), service interfaces (204), an orchestration engine (206), a state management and synchronization engine (208), a contextual information provision engine (210), and a monitoring and analytics module (212). The data repository (202) may correspond to the data repository discussed above and in FIG. 1. As another example, the data repository (202) may be a separate data repository that maintains separate data. If separate, the combination of data repositories store task structures, agent profiles, communication logs, and other information.

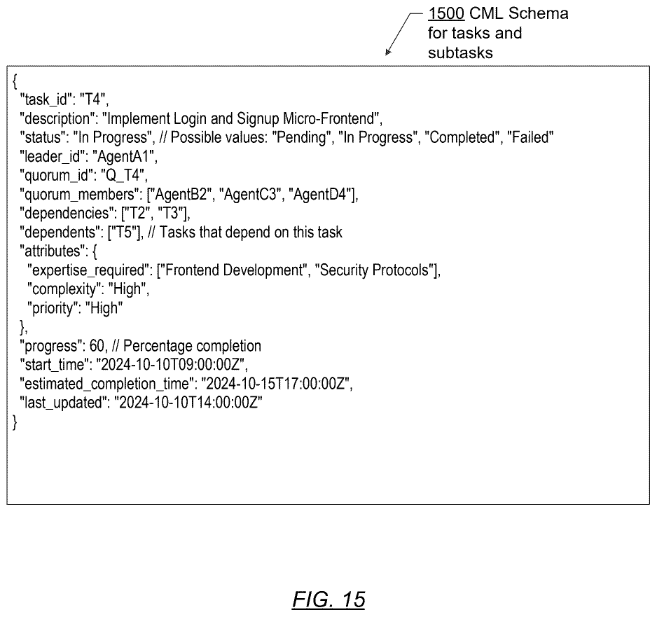

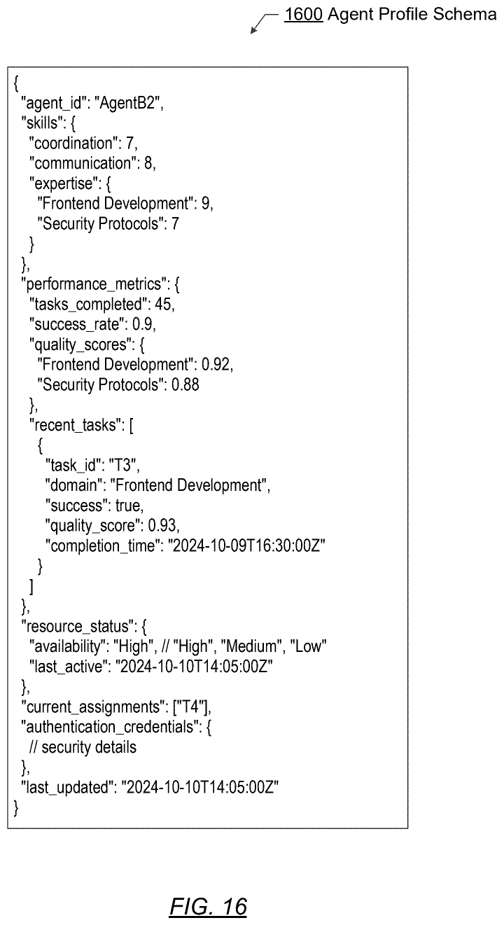

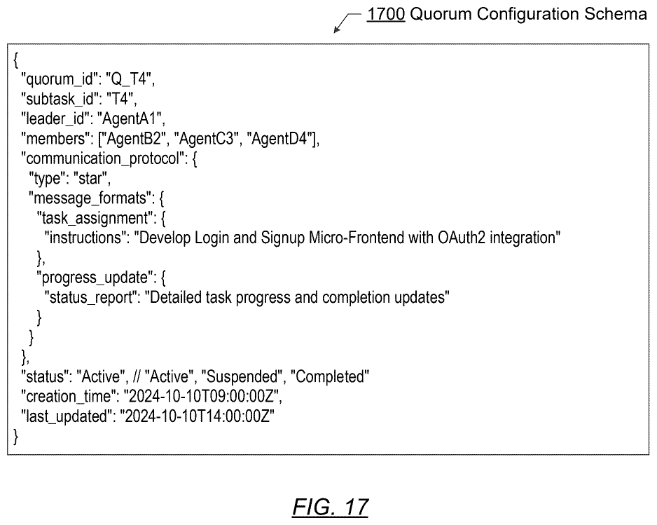

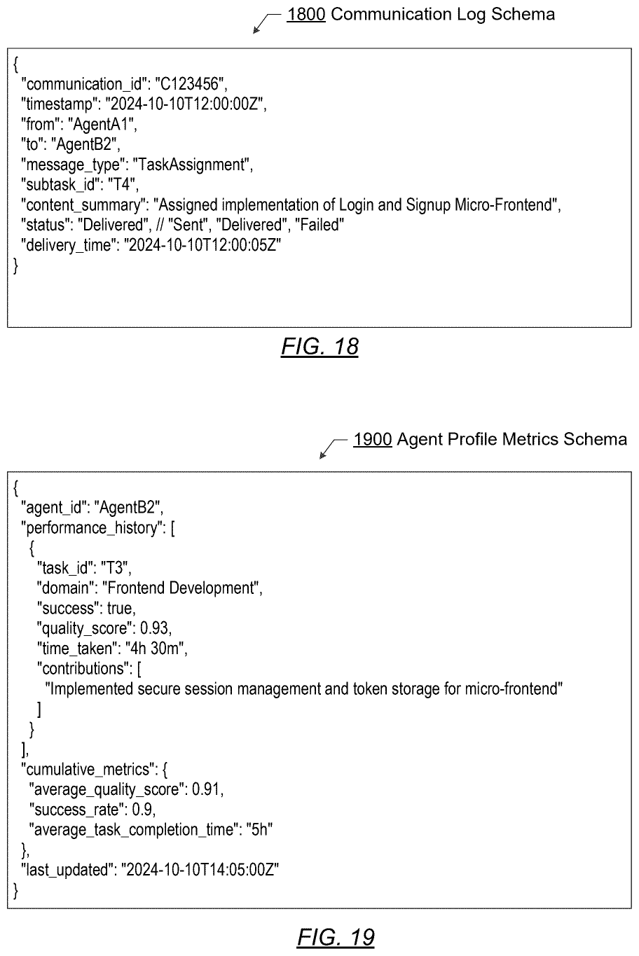

The data repository (202) is a centralized database that stores critical data, including task structures, agent profiles, performance metrics, communication logs, and system states. The performance metrics may include metrics related to how the agent model performs the type of subtask and leadership metrics regarding how the agent is a leader (e.g., coordination skills). The data repository ensures data consistency and integrity across the system. The data repository is for scalability and high availability using distributed database technologies. Further, as shown in FIG. 2, the data repository (202) includes functionality to store various schemas. Each schema provides a standardized structured format to store corresponding data. The schemas include a task representation schema (214), an agent profile schema (216), a quorum configuration schema (218), a communication log schema (220), agent performance metric schema (222). The task representation schema (214) is a schema for storing a task representation. The task representation has the properties of subtasks of the task. An example of a task representation complying with the task representation schema is presented in FIG. 15. The agent profile schema (216) is a standardized format for storing the agent profile. An example of an agent profile complying with the agent profile schema (216) is presented in FIG. 16. The quorum configuration schema (218) is a standardized format for storing a quorum configuration representation. An example of a quorum configuration representation complying with quorum configuration schema is presented in FIG. 17. A communication log schema (220) is a standardized format for storing a communication log entry detailing a communication between various components of the system. An example of a communication log entry complying with communication log schema is presented in FIG. 18. An agent performance metric schema (222) is a standardized format for storing agent performance metrics detailing feedback of how an agent model performed with a particular subtask. An example of agent performance metrics complying with agent performance metric schema (222) is presented in FIG. 19.

Continuing with FIG. 2, the service interface application programming interfaces (APIs) (204) is an interface layer between the central CML and the agent models in the quorums. The service interface APIs include APIs and protocols that provide standardized access to CML services for agent models and leader agent models. The service APIs (204) provides standardized interfaces for agents, leaders, and quorums to interact with the CML, supports RESTful APIs, WebSockets, or gRPC protocols for real-time communication, and implements authentication and authorization mechanisms to enforce security and access control based on roles and permissions.

The orchestration engine (206) manages the workflow execution of tasks and subtasks according to the DAG, coordinates dynamic leader election, quorum formation, and resource allocation, and monitors task dependencies and triggers the execution of dependent tasks upon completion of prerequisite subtasks. An advanced LLM based orchestrator may be used to power the uber level orchestration. The orchestration engine (206) is a software component that manages workflow execution, leader election, quorum formation, and monitors task dependencies. The orchestration engine (206) includes a central machine learning model that is configured to translate a natural language task into a task representation that is in a structured format. For example, the central machine learning model may be a specially trained large language model (LLM). The specially trained LLM may be a general LLM that is further trained to decompose a task into subtasks. The additional training may be supervised or unsupervised training.

The state management and synchronization engine (208) maintains the current state of all tasks, agents, and quorums, provides transactional operations to ensure atomicity and consistency during state updates, and synchronizes state changes across all system components to prevent conflicts and data inconsistencies. The state management and synchronization engine (208) is a software process that is configured to manage the current state of tasks and agent models. The state management and synchronization engine (208) ensures consistency across the system.

The monitoring and analytics module (212) is a software process that monitors the progress of the agent models and the performance of tasks. The monitoring and analytics module (212) continuously tracks system performance, agent activities, task progress, and communication efficiency, provides real-time dashboards, alerts, and logs for system administrators, and employs analytics algorithms to detect anomalies, predict potential failures, and optimize resource utilization. The monitoring and analytics module tracks system performance, provides dashboards, and generates alerts for anomalies.

The contextual information provision (210) is software configured to extract context information for performing subtasks. The contextual information provision (210) is configured to supply relevant context and historical data to agent models and quorums for informed decision-making. The contextual information provision (210) supplies relevant context to agents and quorums, such as task parameters, historical data, and environmental variables, and supports context-aware decision-making by providing agents with the necessary information to perform their roles effectively.

While FIG. 1 shows a configuration of components, other configurations may be used without departing from the scope of one or more embodiments. For example, various components may be combined to create a single component. As another example, the functionality performed by a single component may be performed by two or more components.

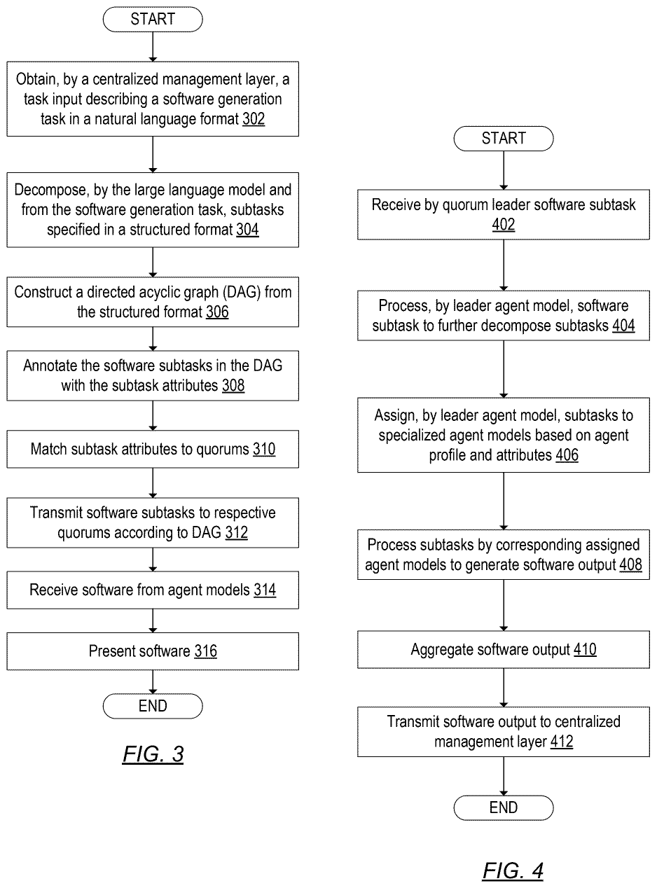

FIG. 3 and FIG. 4 show flowcharts in accordance with one or more embodiments. While the various steps in these flowcharts are presented and described sequentially, at least some of the steps may be executed in different orders, may be combined or omitted, and at least some of the steps may be executed in parallel. Furthermore, the steps may be performed actively or passively.

FIG. 3 shows a flowchart of operations of a central context management layer in accordance with one or more embodiments. Specifically, FIG. 3 shows a flowchart for a centralized CML to process a new request for task generation. Block 302 includes obtaining, by a centralized management layer, a task input describing a software generation task in a natural language format. In a graphical user interface, a user may submit a natural language description of software that the user wants to generate. For example, the user may submit a request that states to generate “a website with an interactive graphical user interface that allows a particular user to update only their own name in a particular database.”

Block 304 includes decomposing, by the large language model, the software generation task into subtasks specified in a structured format. The LLM is a transformer model that interprets the intent of the user's request into a task. The LLM further decomposes the task into subtasks. For example, in the above example, through processing, the LLM may recognize the graphical user interface, update name in backend database, and other aspects. The LLM may further use context data to determine that the user should be authenticated to update the particular database. The output of the LLM is a task representation that is a structured format listing subtasks and the dependencies between the subtasks. The LLM may further recognize the subtask attributes of the respective subtasks and populate the structured representation with the subtask attributes.

Block 306 includes constructing a directed acyclic graph (DAG) from the structured format. For each subtask in the DAG, a node is created. At least one of the subtask attributes in the structured representation includes a listing of dependent subtasks that depend on the subtask being completed. If no dependents exist, then the subtask is a leaf. For each dependent, an edge is created from the subtask to the dependent in the DAG. By creating a DAG, an explicit ordering may be placed on the subtasks.

Block 308 includes annotating the software subtasks in the DAG with the subtask attributes. In one or more embodiments, nodes in the DAG may be appended with the subtask attributes of the subtask as listed in the structured representation.

Block 310 includes matching subtask attributes to quorums. The system compares the subtask attributes to the quorum data of each quorum. The comparison may be for the expertise that the quorum has as compared to the expertise listed in the subtask attributes. The comparison may also be with respect to other attributes, such as the metrics. The matching may be identical attributes to data or based on degree of similarity. The closest matching quorum that has quorum data matching the subtask attributes is the respective quorum for the subtask. The process may be repeated for each subtask.

Block 312 includes transmitting software subtasks to respective quorums according to DAG. The DAG defines an ordering of transmitting software subtasks to quorums. When the software subtasks on which the current subtask is dependent as specified in the DAG is completed, the central CML may send the current subtask to the respective quorum. The context and the software may be sent as needed to the respective quorum. The leader agent model in the quorum initiates processing of the subtask by the quorum.

Block 314 includes receiving software from agent models. The agent models transmit the software to the central CML in one or more embodiments. The CML combines the software from different agent models. For example, the CML may combine the backend portion to the frontend portion. The combination may be performed as part of Block 312 when transmitting software to another agent model.

Block 316 includes presenting software. The software may be transmitted to the user, such as in one or more files. As another example, the software may be stored. In some embodiments, the software is executed. For example, one or more computer processors may execute the software directly or by an interpreter. As another example, if the software is a web application, the web application may be executed when transmitted for execution.

Feedback may be used to create updated performance metrics. Specifically, the feedback may be linked to the particular agent model. The feedback is transmitted central CML that updates the performance metrics of the agent model.

FIG. 4 shows a flowchart of operations of the leader agent model in accordance with one or more embodiments. Block 402 includes receiving by quorum leader, software subtask. Various procedures for performing interprocess communication may be performed to transmit and receive the software subtask.

Block 404 includes processing, by leader agent model, software subtask to further decompose subtasks. The quorum is the expert group for the particular type of subtask. The leader agent model may perform substantially the same process as the central CML, but with the subtask assigned to the quorum rather than the task. The assignment of a subtask, whether to a quorum or an agent model, may be referred to as a subtask assignment. The leader agent model may be or include a specifically trained LLM that is specifically trained on the type or types of subtasks. The leader agent model processes the subtask to decompose the subtask into a structured representation having subtasks of the subtask (i.e., sub-subtasks).

Block 406 includes assigning, by leader agent model, subtasks to specialized agent models based on agent profile and attributes. The leader agent model may match the subtask attributes of the subtask to the properties of the agent model. If the subtask is further decomposed, sub-subtasks of the structured representation are matched to agent models in the quorum based on properties of the agent models and the subtask attributes. The matching process may be performed as described in FIG. 3. In some cases, multiple agent models are assigned to the same subtask.

Block 408 includes processing subtasks by corresponding assigned agent models to generate software output. The agent models are generative models that are configured to process the subtask and corresponding context data to generate software. The agent models may not have been specifically trained on the subtask, and may be specifically trained on the type, such as by having various training experiences on the subtasks of the type.

Block 410 includes aggregating software. The software from the various agent models is aggregated using the performance metrics of the agent models. For example, if a difference exists between software generated by different agent models, the software of one of the agent models may be selected based on how closely the performance metric of the respective agent models matches the subtask attributes of the subtask. The various agent models in the quorum may vote using the software and the performance metrics as input to determine which particular software output of an agent model should be used for the subtask. The result of Block 410 is software for the subtask.

Block 412 includes transmitting software to the centralized management layer. The software is transmitted to the central CML using the service interface. The central CML combines the software and further transmits to other quorums as described in FIG. 3.

To provide for fault tolerance and recovery of the system, heartbeat mechanisms may be used. The heartbeat mechanism includes regular signals from agent models and leader agent models to the central CML to facilitate failure detection. Automated recovery procedures may involve the central CML coordinating leader re-election, task reassignment, and quorum adjustments upon detecting failures with the help of a central orchestrator. State checkpointing includes periodic saving of system state which enables recovery and continuity of operations.

The following are example implementations for performing the processing in accordance with one or more embodiments. Embodiments may differ from the implementation presented below without departing from the scope of the invention.

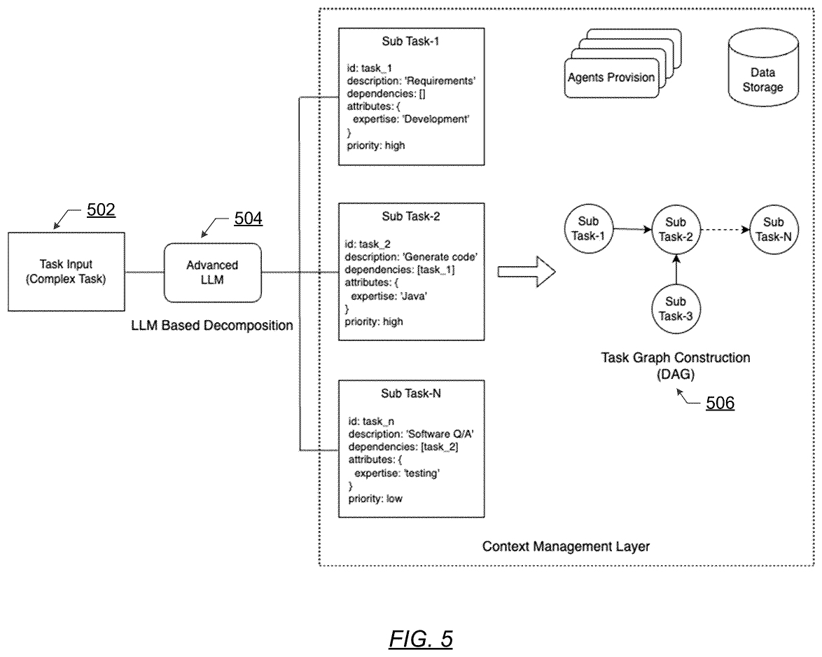

FIG. 5 shows a diagram of hierarchical task decomposition in accordance with one or more embodiments. As shown in FIG. 5, the task decomposition includes the following operations. Task input (502) may involve the system receiving a complex task described in natural language or in the form of a structured system output for embedded systems. LLM based decomposition (504) may include an advanced LLM analyzing the task and identifies subtasks and their dependencies. The output may be structured in a machine-readable format (e.g., JSON), detailing subtasks and their relationships.

Task graph construction (506) includes creating a DAG from the LLM output. Nodes represent subtasks and edges represent dependencies. Each subtask is annotated with attributes, such as required expertise, estimated complexity, and priority level.

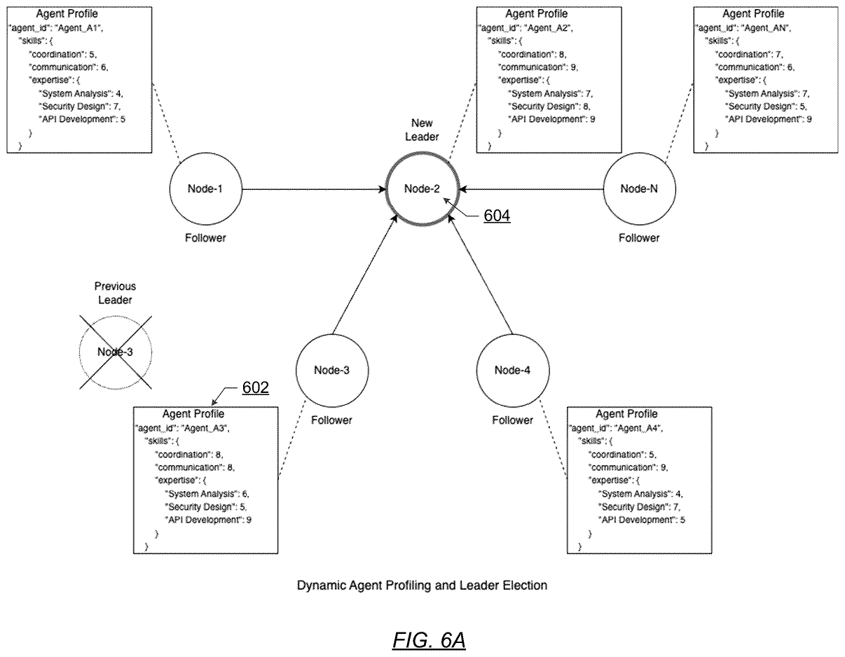

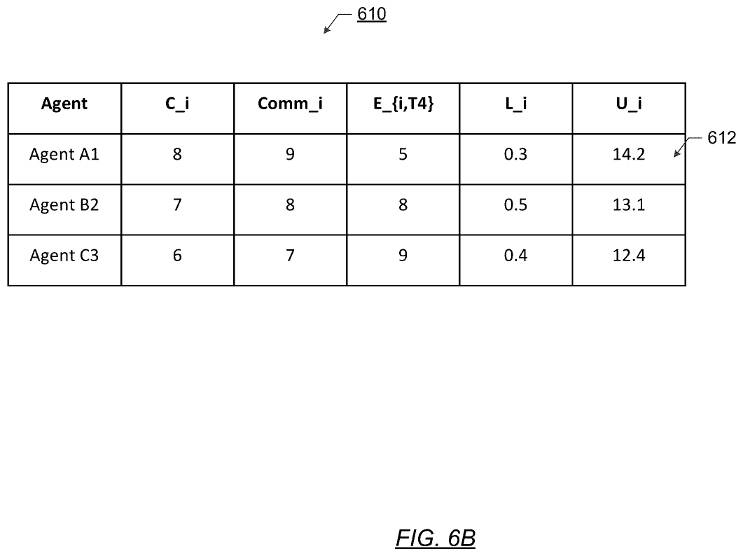

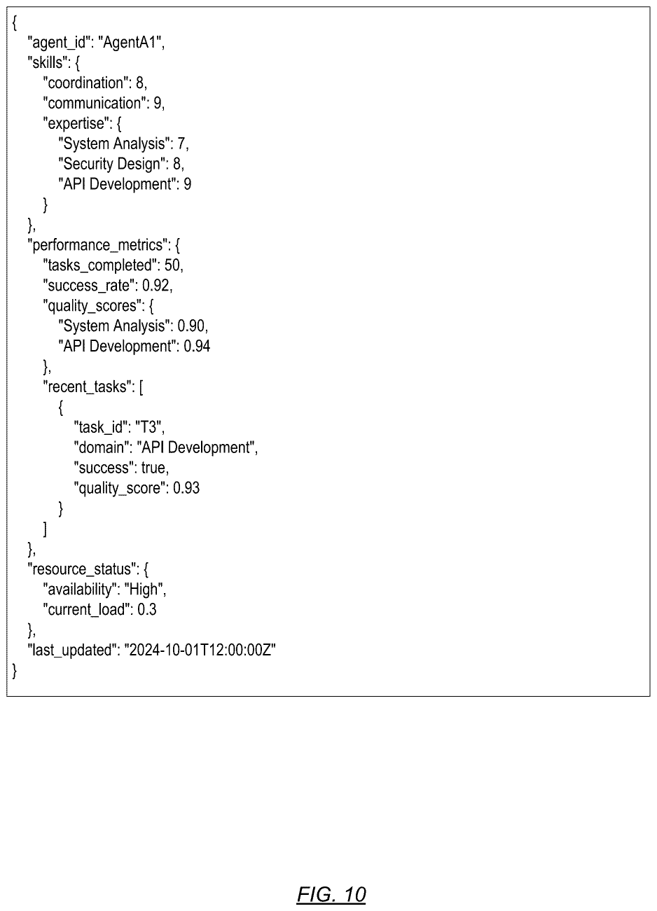

FIG. 6A shows a diagram of a quorum (604) in accordance with one or more embodiments. Agent profiles may be continuously updated based on the performance metrics and quorum leaders are selected best suited for coordinating specific subtasks as shown in FIG. 6A. As shown in FIG. 6A, the agent profile (e.g., agent profile for Agent_A3 (602)) includes the agent identifier, the skills that the agent is determined to have, such as coordination, communication, and expertise. FIG. 10 below shows an example data structure storing the agent profile.

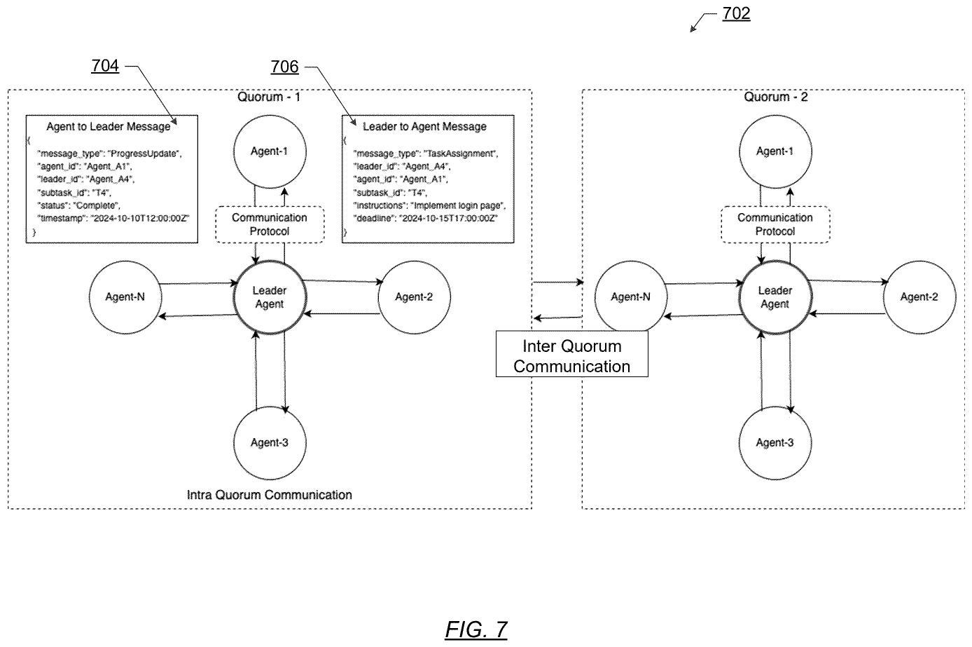

FIG. 7 shows inter quorum and intra quorum communication diagrams (702) in accordance with one or more embodiments. As shown in FIG. 7, different message types exist including process update messages (704) from the agent model to the leader and task assignment messages (706) from the leader to the agent model. Inter quorum communication may be performed between quorums to update the quorums.

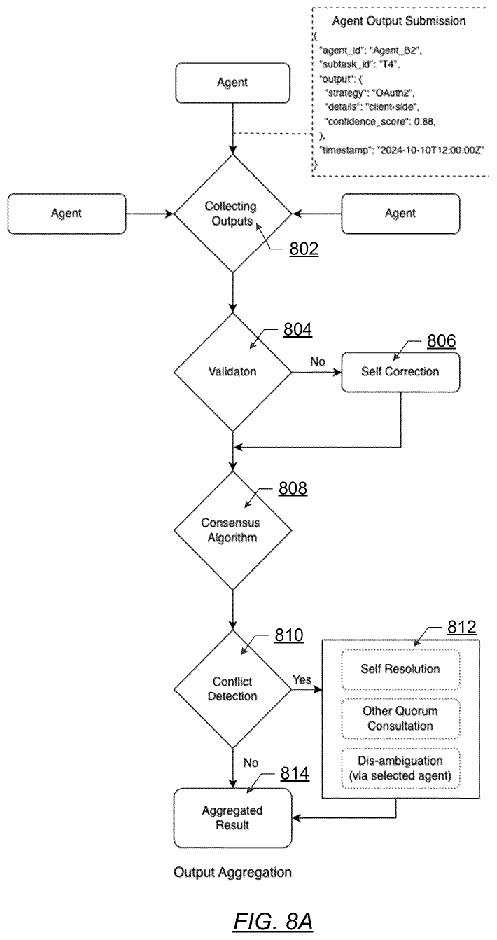

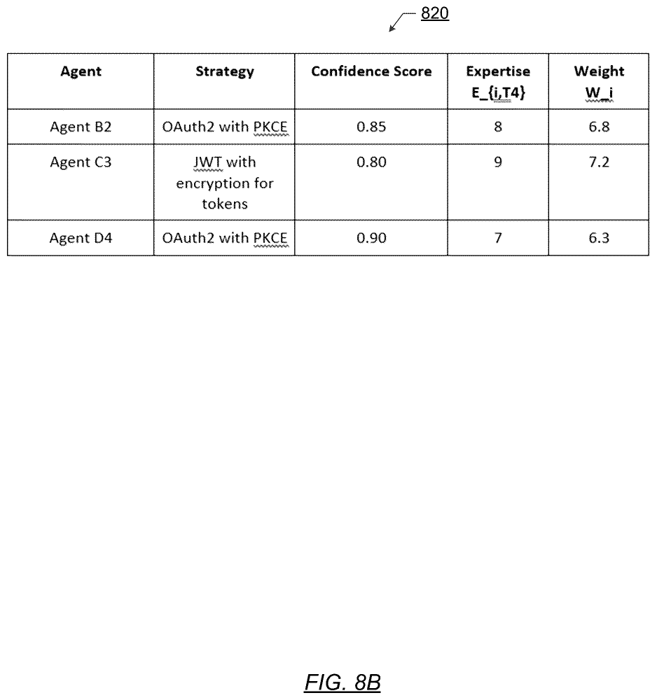

FIG. 8A shows a diagram of aggregating results from multiple agents in accordance with one or more embodiments of the invention. The operational workflow includes the following. Task allocation includes the agentic leader assigns specific tasks to agents based on their strengths, using data from the central CML. The agentic leader can also break the subtask into smaller subtasks if required. Information sharing includes agents sharing findings and progress reports with the leader. Leader coordination is performed to ensure synchronization among agents and resolves any issues.

As shown in FIG. 8A, the leader integrates disparate agent outputs effectively, even when faced with conflicting information as shown in below figure. For example, the leader agent model collects outputs (802) from different agents and validates the outputs (804). The leader verifies outputs for completeness and adherence to the standardized format. If the outputs cannot be validated, then self-correction may be attempted (806). A consensus algorithm (808) is then performed to determine if the agent models have a consensus or a difference. Consensus Algorithm: Here consensus algorithms like PAXOS, RAFT, or Weighted Aggregation method can be used, which can be defined using Eq. 1.

$${D}_{k} = \frac{{\sum }_{i ϵ {Q}_{k}} {W}_{i} \times {d}_{i}}{{\sum }_{i ϵ {Q}_{k}} {W}_{i}} \qquad ( Eq . 1 )$$

In Eq. 1, (Dₖ) is an aggregation decision for subtask (k), (dᵢ) is the output value from agent (i) (e.g., a numerical representation), and (Wᵢ) is the weight assigned to agent (i). E is the expertise of the agent (i) for the task (k) and is based on the confidence as defined in Eq. 2.

$${W}_{i} = {E}_{ik} \times Confidence Score \qquad ( Eq . 2 )$$

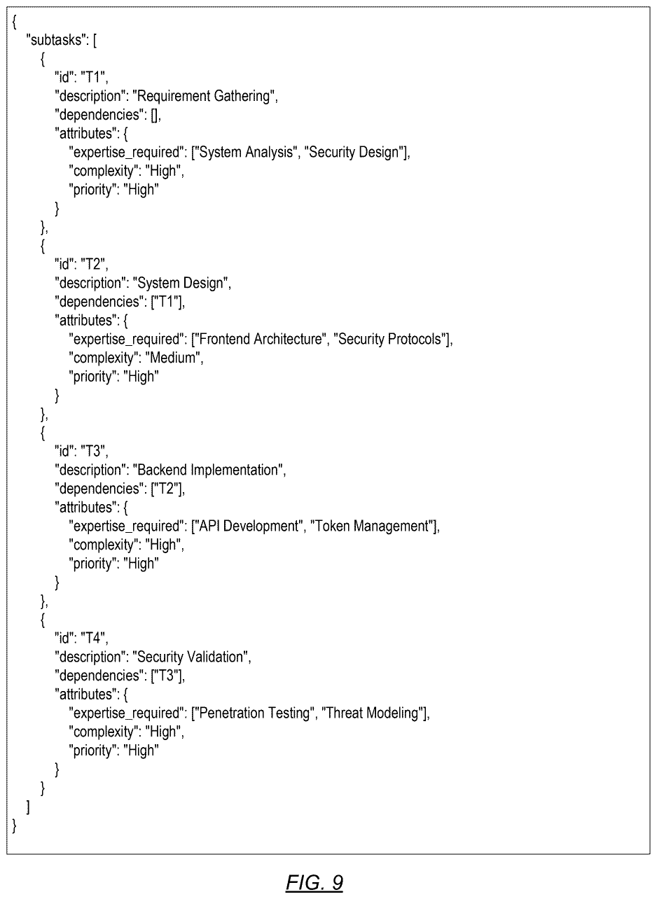

If a difference exists, a determination may be made whether the difference is a conflict through conflict detection (810). If a conflict is detected, different actions (812) may be performed using self-regulation, consulting other quorums, and performing disambiguation. An analysis is performed. The leader examines the aggregated results and identifies any discrepancies. The leader may request additional information or clarification from agents. The leader, possibly in consultation with the context management layer, may finalize the aggregated output. The result is an aggregated result (814) that is the output. The output may comply with the output schema shown in FIG. 9.

FIG. 8B shows an example conflict resolution process (820) in accordance with one or more embodiments. Each agent model has produced code with a corresponding strategy. A confidence score is produced by the agent models in the strategy. The expertise and the weights of the agents are also shown. As shown, the total weight for OAuth2 with PKCE is (6.8+6.3=13.1), the total weight for JWT with encryption for tokens is (7.2). Thus, the selected strategy is OAuth2 with PKCE due to higher cumulative weight.

FIG. 9 shows an example output schema (900) in accordance with one or more embodiments. The example output is a task representation produced by the LLM that is in a structured format. The example output is for the input task: “Develop a secure user authentication module for a multi-tenant web application.” As shown in FIG. 9, the task is partitioned into four subtasks, each with a corresponding identifier (T1, T2, T3, T4). The task includes a description of the subtask and attributes. The attributes may include expertise, complexity, and priority. The CML then performs data storage to store the task DAG, subtask details, and annotations, access provision to provide agents and quorums with up-to-date task structures and dependencies, and state management to maintain the current state of each subtask, including progress and completion status.

FIG. 10 shows an example agent profile structure (1000) in accordance with one or more embodiments. The agent profile structure includes skills, different expertise that the agent model has, a ratings of the agents in the expertise, and performance metrics. The performance metrics of the agent may include the number of tasks completed, success rate of completion, the quality score, and the recent tasks.

From the agent profile structure, an expertise score (Eᵢₖ) may be calculated for agent (i) in domain (k) using a weighted average of the agent's historical performance in that domain, such as by using the following equation (Eq. 3).

$${E}_{ik} = \frac{{\sum }_{j = 1}^{{N}_{ik}} {Q}_{ij} \times {S}_{ij} \times {W}_{ij}}{{\sum }_{j = 1}^{{N}_{ik}} {W}_{ij}} \qquad ( Eq . 3 )$$

In Eq. 3, (Nᵢₖ) is the total number of tasks agent (i) has completed in domain (k). (Qᵢⱼ) is the quality score of agent (i) on task (j) in domain (k), ranging from 0 to 1. (Sᵢⱼ) is the success indicator for task (j) (e.g., 1 if successful, 0 if not). (Wᵢⱼ) is the weight assigned to task (j), such as recency (more recent tasks have higher weight). The quality score (Qᵢⱼ) may be calculated based on predefined criteria specific to the task domain, such as accuracy, efficiency, and adherence to requirements. The quality score may be determined by the leader agent model of the quorum or via an automated validation process (e.g., could be done via an evaluation metric or human expert driven). The success indicator (Sᵢⱼ) may be a binary value indicating whether the agent successfully completed task (j). The success indicator may be determined by task completion status and acceptance of the output by the leader or downstream processes. Upon task completion the outcome is stored in the context management layer.

Returning to FIG. 6A, the leader election process may proceed as follows. First candidate leaders may be identified. Agent models with the expertise score (Eᵢₖ) above a threshold are selected as a candidate for leadership of subtask. A utility score is calculated using equation Eq. 4 as follows.

$${U}_{i} = {λ}_{1} {C}_{1} + {λ}_{2} {Comm}_{i} - {λ}_{3} {E}_{ik} - {λ}_{4} {L}_{i} \qquad ( Eq . 4 )$$

In equation Eq. 4, (C₁) is the coordination skill, (Commᵢ) is the communication efficiency, (Lᵢ) is the current load factor (ranges from 0 to 1), and (λₙ) is the weight coefficients reflecting the importance of each attribute. The leader selection may be performed as follows. The agent with the highest utility score (Uᵢ) is selected as the leader for subtask. The chosen agentic leader orchestrates the subtasks via a quorum of multiple LLM agents.

Agents are matched to subtasks based on similarities and to quorums based on similarities between agents. Agent matching includes determining a similarity Score (Sik) between agent (i) and subtask (k) as shown in Eq. 5.

$${S}_{ik} = \frac{{\sum }_{j = 1}^{m} {E}_{ij} \times {R}_{kj}}{\sqrt{{\sum }_{j = 1}^{m} {E}_{ij}^{2}} \times \sqrt{{\sum }_{j = 1}^{m} {R}_{kj}^{2}}} \qquad ( Eq . 5 )$$

In Eq, 5, (Eᵢⱼ) is the expertise score of agent (i) in skill (j), (Rₖⱼ) is the required expertise level for subtask (k) in skill (j), and (m is the total number of skills. Agents with the similarity score above the predefined threshold are included in quorum (Qₖ). The similarity score (Sᵢₖ) is adjusted based on subtask complexity and urgency, determined by the leader in consultation with the central CML.

FIG. 6B shows an example table (610) of a leader election process. As shown in FIG. 6B, consider the scenario in which the weights are (λ_1=0.4), (λ_2=0.3), (λ_3=0.2), and (λ_4=0.1). The candidate agents for Subtask T4 may be designated as shown in the table. Based on the utility score (Uᵢ), Agent A1 (612) is selected as shown in FIG. 6B.

In performing the leader election, the central CML may provide the following. The central CML may perform profile management to store and update agent profiles with the latest performance metrics and expertise scores. The central CML may perform calculation support to provide necessary data for calculating (Eᵢₖ), (Qᵢⱼ), and (Sᵢⱼ). Further, the central CML may facilitate leader election by supplying agents and quorums with updated information to support decision-making processes.

FIG. 11 shows an example of a leader to agent message (1100) in accordance with one or more embodiments. The leader to agent message includes the message type, leader identifier, agent identifier, and a subtask identifier. The leader to agent message further includes instructions and a deadline. For a task assignment message type, the instructions are natural language instructions of the task and a deadline.

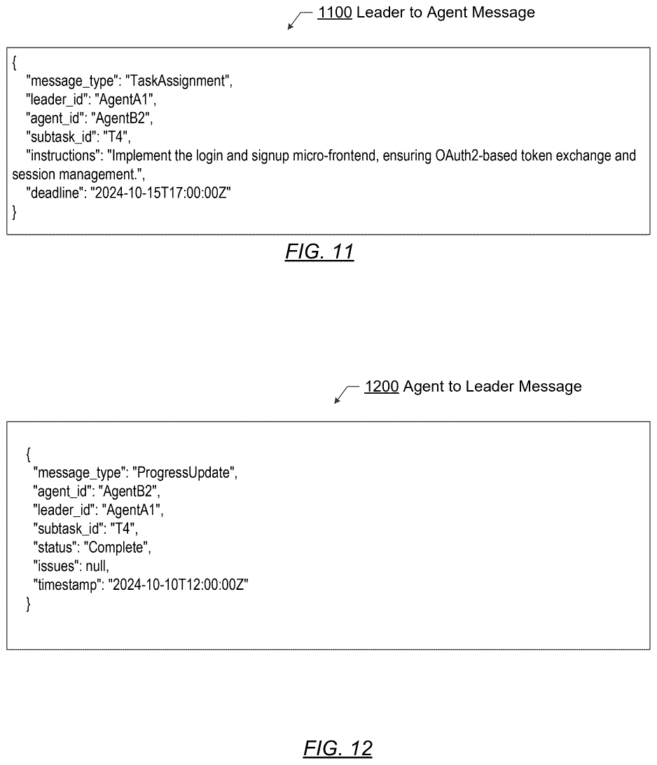

FIG. 12 shows an example of an agent to leader message (1200) in accordance with one or more embodiments. The agent to leader message may also include the message type, leader identifier, agent identifier, and a subtask identifier. For the progress update message type, the status may be null, and any issues are presented. In the example, the issues are null. However, if issues exist, the issues may be in a natural language.

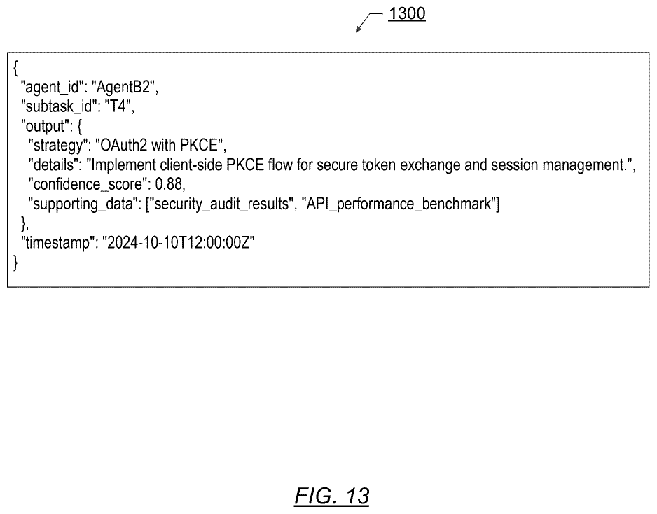

FIG. 13 shows an example output of an agent model (1300) in accordance with one or more embodiments. Agent models submit output using schemas in accordance with one or more embodiments. The output includes an agent identifier, subtask identifier, and information about the output. The actual code may be in the same output or in a different output format.

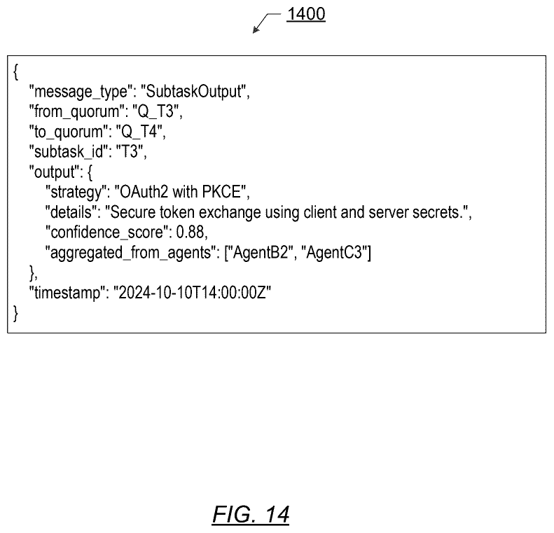

FIG. 14 shows an example inter quorum message (1400) in accordance with one or more embodiments. The inter quorum message (1400) may include the quorums, strategy, details, and which agents generated the aggregated output. Communication flow is based on the DAG, outputs from subtasks are transmitted to dependent quorums via the central CML.

A hierarchical aggregation process may be performed. For input integration, the quorum leader retrieves inputs from the central CML. During consensus formation, inputs may be combined using weighted aggregation/consensus methods similar to intra quorum aggregation. Coordination is performed across quorums, so that leaders may collaborate directly or through the context management layer to align strategies. The role of the central CML during hierarchical aggregation is to manage the exchange of messages between quorums, ensuring data integrity and security, perform state management to keep track of subtask outputs and their availability for downstream tasks, and perform data access control to regulate permissions for quorums to access necessary information.

FIG. 15 shows an example output (1500) separating tasks and subtasks in accordance with one or more embodiments. The CML stores tasks and subtasks using a structured schema that encapsulates all necessary information for execution and management.

FIG. 16 shows an example of an agent profile with an agent profile schema (1600) in accordance with one or more embodiments. As shown in FIG. 16, agent profiles (1600) are stored and continuously updated in the CML, containing comprehensive information about the agent's capabilities and performance.

FIG. 17 shows an example of a quorum configuration according to a quorum configuration schema (1700) in accordance with one or more embodiments. The schema in FIG. 17 allows the CML to maintain the configuration and state of each quorum.

FIG. 18 shows an example of a communication log entry according to a communication log schema (1800) in accordance with one or more embodiments. The CML logs significant communications for audit, monitoring, and fault tolerance purposes.

FIG. 19 shows an example of an agent profile metrics (1900) according to an agent profile metrics schema (1900) in accordance with one or more embodiments. The CML tracks detailed performance metrics for each agent to support dynamic profiling and leader election.

Agent models have a dynamic role to adapt to changes in order to be more adaptable. By allowing for dynamic roles, one or more embodiments allow for changing task requirements or variations in agent capabilities. Further, one or more include voting amongst agent models that accounts for metrics of the agent models in order to produce more accurate decisions. The HLQS is scalable as more agent models may be added to the quorum system. Further, when agent models are added, replication of agent models may provide for a more robust system to fail.

The following is an example workflow using the context management layer. Task decomposition is performed whereby the LLM decomposes the task and sends the structured DAG to the CML, and the CML stores the task hierarchy and makes it accessible via API. Further, agent profiling and leader election is performed. Agents' performance data is updated in the CML after each task. When a new subtask starts, the CML calculates expertise and utility scores. The CML provides the list of candidate leaders to the quorum for selection.

Further, the quorum is formed. The leader requests agent matching from the CML, specifying required expertise and similarity thresholds. The CML returns a list of suitable agents. The quorum is formed and registered in the CML.

Task execution and communication involves agents and leaders communicating using message formats and protocols defined in the CML, and communication logs are stored in the CML for auditing and monitoring.

The outputs are aggregated, and consensus is performed. Agents submit outputs to the leader. The leader uses aggregation algorithms provided by the CML. Aggregated outputs are stored in the CML and made available to dependent tasks.

Fault detection and recovery may be performed as follows. The CML detects a leader's failure via missed heartbeats and notifies quorum members and facilitates a new leader election. The new leader retrieves the latest state from the CML and continues task execution.

Fault tolerance and recovery mechanisms can be performed as follows. The system ensures reliability by handling agent or leader failures effectively. Failure detection may be performed using a heartbeat mechanism whereby agents and leaders send periodic heartbeat messages to the central CML. Absence of heartbeats within a specified timeout triggers failure protocols.

When the central CML identifies missing heartbeats from a leader, the CML notifies the quorum members of the leader's failure. A re-election process is performed whereby remaining agents recalculate utility scores using updated data from the central CML. The agent with the highest (Uᵢ) becomes the new leader. State synchronization is performed by the new leader retrieving the latest task state from the central CML.

The role of the central CML includes monitoring (e.g., continuously tracks the health of agents and leaders), coordination (e.g., facilitates re-election and recruitment processes by providing necessary data and recommendations), and data integrity (e.g., ensure that the system state remains consistent during transitions).

As shown in the example implementation, embodiments provide an integrated framework with central context management for hierarchical task decomposition and agent collaboration. Specifically, a cohesive system utilizes LLMs for task decomposition and interconnects agents through dynamic leader election, adaptive quorum formation, standardized communication protocols, and robust aggregation mechanisms, orchestrated by a central context management layer.

Further, embodiments provide dynamic agent profiling and leader election using continuous performance metrics. Specifically, embodiments provide a method for continuously updating agent profiles based on performance metrics and selecting leaders using these dynamic profiles, ensuring effective subtask management.

Moreover, embodiments provide for adaptive quorum formation with context-aware communication protocols. A system forms agent groups with clear communication structures, facilitated by a central context layer that provides up-to-date information and protocols.

Additionally, embodiments provide for standardized output formats and mathematically robust aggregation methods. Embodiments include techniques for integrating agent outputs using predefined formats and mathematical aggregation methods, enabling precise integration and conflict resolution.

Further, embodiments provide for hierarchical consensus through context-managed inter quorum communication. The hierarchical consensus is a hierarchical approach for integrating decisions across quorums using structured communication protocols, managed by a central context layer, ensuring coherent overall task execution.

Additionally, embodiments provide for fault tolerance mechanisms utilizing a central context layer. Specifically, protocols for detecting agent or leader failures and implementing recovery strategies, coordinated by the context management layer, to maintain system reliability.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

One or more embodiments include hierarchical task decomposition by performing smart task decomposition to be profiled and utilized via quorums and elected leaders. Embodiments may further include dynamic agent profiling and leader election that includes continuously updating agent profiles and selecting leaders based on real-time performance metrics. Embodiments may further include adaptive quorum formation, grouping agents into quorums based on expertise matching and task requirements, supported by standardized communication protocols. Embodiments may further include robust aggregation mechanisms that include utilizing mathematically robust methods for integrating agent outputs and resolving conflicts. Embodiments may further include the central CML that orchestrates the system through centralized data management, synchronization, and context provision. The system further includes fault tolerance and recovery detecting failures and implementing automated leader re-election and state recovery mechanisms.

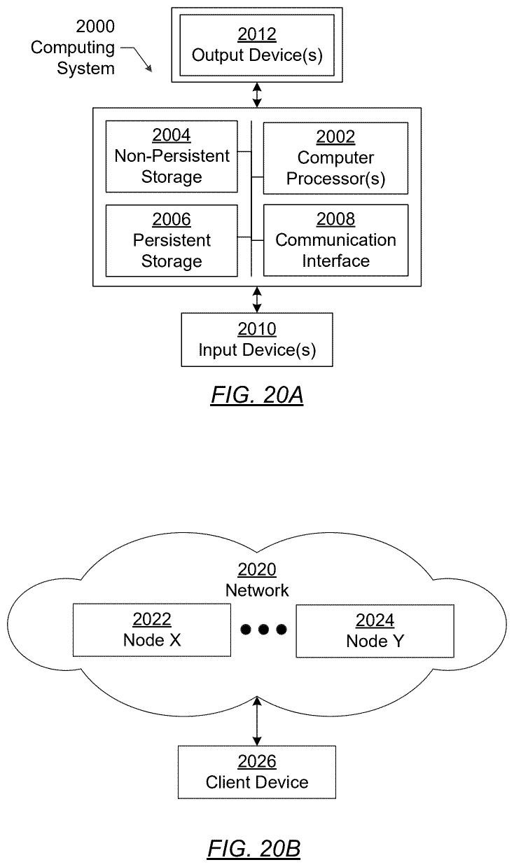

For example, as shown in FIG. 20A, the computing system (2000) may include one or more computer processor(s) (2002), non-persistent storage device(s) (2004), persistent storage device(s) (2006), a communication interface (2008) (e.g., Bluetooth interface, infrared interface, network interface, optical interface, etc.), and numerous other elements and functionalities that implement the features and elements of the disclosure. The computer processor(s) (2002) may be an integrated circuit for processing instructions. The computer processor(s) (2002) may be one or more cores, or micro-cores, of a processor. The computer processor(s) (2002) includes one or more processors. The computer processor(s) (2002) may include a central processing unit (CPU), a graphics processing unit (GPU), a tensor processing unit (TPU), combinations thereof, etc.

The input device(s) (2010) may include a touchscreen, keyboard, mouse, microphone, touchpad, electronic pen, or any other type of input device. The input device(s) (2010) may receive inputs from a user that are responsive to data and messages presented by the output device(s) (2012). The inputs may include text input, audio input, video input, etc., which may be processed and transmitted by the computing system (2000) in accordance with one or more embodiments. The communication interface (2008) may include an integrated circuit for connecting the computing system (2000) to a network (not shown) (e.g., a local area network (LAN), a wide area network (WAN), such as the Internet, mobile network, or any other type of network) or to another device, such as another computing device, and combinations thereof.

Further, the output device(s) (2012) may include a display device, a printer, external storage, or any other output device. One or more of the output device(s) (2012) may be the same or different from the input device(s) (2010). The input device(s) (2010) and output device(s) (2012) may be locally or remotely connected to the computer processor(s) (2002). Many different types of computing systems exist, and the aforementioned input device(s) (2010) and output device(s) (2012) may take other forms. The output device(s) (2012) may display data and messages that are transmitted and received by the computing system (2000). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as, a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (2002), is configured to perform one or more embodiments, which may include transmitting, receiving, presenting, and displaying data and messages described in the other figures of the disclosure.

The computing system (2000) in FIG. 20A may be connected to, or be a part of, a network. For example, as shown in FIG. 20B, the network (2020) may include multiple nodes (e.g., node X (2022) and node Y (2024), as well as extant intervening nodes between node X (2022) and node Y (2024)). Each node may correspond to a computing system, such as the computing system shown in FIG. 20A, or a group of nodes combined may correspond to the computing system shown in FIG. 20A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (2000) may be located at a remote location and connected to the other elements over a network.

The nodes (e.g., node X (2022) and node Y (2024)) in the network (2020) may be configured to provide services for a client device (2026). The services may include receiving requests and transmitting responses to the client device (2026). For example, the nodes may be part of a cloud computing system. The client device (2026) may be a computing system, such as the computing system shown in FIG. 20A. Further, the client device (2026) may include or perform all or a portion of one or more embodiments.

The computing system of FIG. 20A may include functionality to present data (including raw data, processed data, and combinations thereof), such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
decomposing, by a large language model (LLM) of a central context management layer (CML), a software generation task specified in a natural language into a plurality of subtasks specified in a structured format;
matching at least one subtask attribute of each corresponding subtask of the plurality of subtasks to quorum data of a respective quorum of a plurality of quorums to obtain a plurality of subtask assignments;
transmitting, for each subtask assignment of the plurality of subtask assignments, the corresponding subtask to the respective quorum according to the subtask assignment;
assigning, by a leader agent model of the respective quorum, the corresponding subtask to at least one agent model of a plurality of agent models;
processing, by the at least one agent model, the corresponding subtask to generate software;
combining, by the central CML, the software generated by the plurality of quorums; and
presenting, after combining the software, the software.

2. The method of claim 1, wherein the at least one agent model is a specialized agent model specifically trained to generate software for a subtask type of the corresponding subtask.

3. The method of claim 1, further comprising:
receiving, via a graphical user interface, a task input describing a software generation task in a natural language format.

4. The method of claim 1, further comprising:
constructing a directed acyclic graph (DAG) from the structured format;
annotating the plurality of subtasks in the DAG with the plurality of subtask attributes,
wherein transmitting the corresponding subtask to the plurality of quorums is performed in an order defined by the DAG.

5. The method of claim 1, further comprising:
decomposing, by the leader agent model, the corresponding subtask into a second plurality of subtasks;
assigning each subtask of the second plurality of subtasks to the plurality of agent models associated with the quorum;
receiving, from the plurality of agent models associated with the quorum, the software; and
transmitting the software to the central CML.

6. The method of claim 5, further comprising:
aggregating the software from the plurality of agent models according to performance metrics of the plurality of agent models.

7. The method of claim 6, wherein aggregating the software comprises:
determining a difference exists between software of a first agent model of the plurality of agent models and a second agent model of the plurality of agent models;
selecting the software of the first agent model or the second agent model based on a performance metric of the first agent model and the second agent model with respect to the corresponding subtask; and
using the selected software as the software for the corresponding subtask.

8. The method of claim 1, further comprising:
electing, from the plurality of agent models in the quorum, the leader agent model according to a plurality of leadership metrics gathered from the plurality of agent models.

9. The method of claim 1, further comprising:
monitoring the generation of the software by the plurality of agent models; and
updating a plurality of performance metrics based on the monitoring to generate updated performance metrics; and
using the updated performance metrics to select agents for a second software generation task.

10. The method of claim 1, wherein the subtask attribute defines an expertise required to complete the corresponding subtask, and wherein the quorum data defines an expertise of the quorum.

11. A system comprising:
at least one storage device; and
at least one computer processor for executing instructions stored on the at least one storage device for causing the system to perform operations comprising:
decomposing, by a large language model (LLM) of a central context management layer (CML), a software generation task specified in a natural language into a plurality of subtasks specified in a structured format,
matching at least one subtask attribute of each corresponding subtask of the plurality of subtasks to quorum data of a respective quorum of a plurality of quorums to obtain a plurality of subtask assignments,
transmitting, for each subtask assignment of the plurality of subtask assignments, the corresponding subtask to the respective quorum according to the subtask assignment,
assigning, by a leader agent model of the respective quorum, the corresponding subtask to at least one agent model of a plurality of agent models,
processing, by the at least one agent model, the corresponding subtask to generate software,
combining, by the central CML, the software generated by the plurality of quorums, and
presenting, after combining the software, the software.

12. The system of claim 11, wherein the at least one agent model is a specialized agent model specifically trained to generate software for a subtask type of the corresponding subtask.

13. The system of claim 11, wherein the operations further comprise:
receiving, via a graphical user interface, a task input describing a software generation task in a natural language format.

14. The system of claim 11, wherein the operations further comprise:
constructing a directed acyclic graph (DAG) from the structured format;
annotating the plurality of subtasks in the DAG with the plurality of subtask attributes,
wherein transmitting the corresponding subtask to the plurality of quorums is performed in an order defined by the DAG.

15. The system of claim 11, wherein the operations further comprise:
decomposing, by the leader agent model, the corresponding subtask into a second plurality of subtasks;
assigning each subtask of the second plurality of subtasks to the plurality of agent models associated with the quorum;
receiving, from the plurality of agent models associated with the quorum, the software; and
transmitting the software to the central CML.

16. The system of claim 15, wherein the operations further comprise:
aggregating the software from the plurality of agent models according to performance metrics of the plurality of agent models.

17. The system of claim 16, wherein aggregating the software comprises:
determining a difference exists between software of a first agent model of the plurality of agent models and a second agent model of the plurality of agent models;
selecting the software of the first agent model or the second agent model based on a performance metric of the first agent model and the second agent model with respect to the corresponding subtask; and
using the selected software as the software for the corresponding subtask.

18. The system of claim 11, wherein the operations further comprise:
electing, from the plurality of agent models in the quorum, the leader agent model according to a plurality of leadership metrics gathered from the plurality of agent models.

19. The system of claim 11, wherein the operations further comprise:
monitoring the generation of the software by the plurality of agent models; and
updating a plurality of performance metrics based on the monitoring to generate updated performance metrics; and
using the updated performance metrics to select agents for a second software generation task.

20. A method comprising:
decomposing, by a large language model (LLM) of a central context management layer (CML), a software generation task specified in a natural language into a plurality of subtasks specified in a structured format;
matching at least one subtask attribute of each corresponding subtask of the plurality of subtasks to quorum data of a respective quorum of a plurality of quorums to obtain a plurality of subtask assignments;
transmitting, for each subtask assignment of the plurality of subtask assignments, the corresponding subtask to the respective quorum according to the subtask assignment;
assigning, by a leader agent model of the respective quorum, the corresponding subtask to at least one agent model of a plurality of agent models;
processing, by the at least one agent model, the corresponding subtask to generate software;
combining, by the central CML, the software generated by the plurality of quorums; and
executing, after combining the software, the software.
